(19) United States
(12) Patent Application Publication
(10) Pub. No.: US 2012/0247266 A1
(43) Pub. Date: Oct. 4, 2012

(54) SLIDE HANDLER

(75) Inventors: Nao Takagi, Tokyo (JP); Shinya Mizuno, Kanagawa (JP)

(73) Assignee: PIONEER CORPORATION, Kanagawa (JP)

(21) Appl. No.: 13/511,426

(22) PCT Filed: Dec. 6, 2010
(86) PCT No.: PCT/JP2010/007082

§ 371 Date: May 23, 2012

(51) Int. Cl. G05G 1/00

(52) U.S. Cl. 74/548

(57) ABSTRACT

A slide handler 1 mounted on a top end side of a handle lever 5 of which a base end side is attached to a slider 9 of an operated portion has a handler body 2 that has a lever reception portion 7 in which the handler lever 5 is received, a mount attachment 3 that has a lever locking portion 21 relatively fitted and mounted in the lever reception portion 7 in a state that the lever locking portion 21 is locked on the handle lever 5 and that has a hook portion 22 hooked in the lever reception portion 7 in a state that the fitting and mounting is completed, and a pressing member 4 that is detachably mounted on the handler body 2 and presses the hook portion 22 in the lever reception portion 7 in a hooking direction.

### TECHNICAL FIELD

The present invention relates to a slide handler which is mounted on a top end side of a handle lever of which a base end side is attached to a slider of an operated member.

### BACKGROUND ART

Generally, there has been known a handle tab of an arc-shaped fader as this kind of slide handler (see Patent Document 1). In the arc-shaped fader, a lever shaft is attached to a flange-like movable piece (slider) and the flange-like movable piece is slidably supported in an arc-shaped slits which are formed in a right frame and a left frame, respectively. A handle tab (slide handler) is mounted to fit on a top end portion of the lever shaft.
[Patent Document 1] JP-A-11-233318

### DISCLOSURE OF THE INVENTION

### Problems that the Invention is to Solve

Since such a known handle tab (slide handler) is attached to fit on the top end portion of the lever shaft (handle lever) by light press fitting or the like, backlash develops between the handle tab and the lever shaft over frequent usage. When attrition therebetween progresses, there arises a problem such that the handle tab can be easily pulled off (can be lost). While, in a case that the handle tab is designed to be pressed strongly to fit on the lever shaft, a problem may be envisioned in which the handle tab can not be readily exchanged when it breaks.

It is an advantage of the invention to provide a slide handler which can be mounted in a securely retained state on a handle lever and can be easily detached therefrom as necessary.

### Means for Solving the Problems

According to one aspect of the invention, there is provided a slide handler mounted on a top end portion of a handle lever of which a base end side is attached to a slider of an operated portion having a handler body that has a lever reception portion in which the handle lever is received, a mount attachment that has a lever locking portion relatively fitted and mounted in the lever reception portion in a state that the lever locking portion is locked on the handle lever and that has a hook portion hooked in the lever reception portion in a state that the fitting and mounting is completed, and a pressing member that is detachably mounted on the handler body and presses the hook portion in the lever reception portion in a hooking direction.

According to the structure, when the mount attachment is relatively fitted and mounted in the lever reception portion of the handler body in a state that the lever locking portion is locked on the handle lever, the hook portion of the mount attachment is hooked in the lever reception portion. This makes the handler body immovably mounted on the handle lever. Further, the pressing member is mounted on the handler body in that state, the hook portion is pressed in the lever reception portion in a hooking direction, thereby the handler body is in a locked state on the handle lever by way of the hook portion. While, the pressing member is detached from the handler body from the locked state, the locked state is released. In short, it is possible to mount the handler body on the handle lever securely in the locked state and is possible to easily detach the handler body as needed. It is preferable that the hook portion is strong against a tension direction and weak against a bending direction. Still further, since a configuration of the handler lever in AV equipment is almost identical, it is generally possible to attach the slide handler of the invention on new and existing handle levers.

In this case, it is preferable that the hook portion exert spring force in a bending direction including the hooking direction, and the lever reception portion have a hook reception portion on which the hook portion is hooked, a guide groove that guides relative hooking action of the hook portion in a free state on the hook reception portion, and a hooking introduction portion that is provided between the hook reception portion and the guide groove and bends the hook portion just before hooking from the free state.

According to the structure, when the mount attachment is relatively fitted and mounted (hooking action) in the lever reception portion of the handler body, the hook portion relatively moves along the guide groove in the free state, thereby the mount attachment does not receive the spring force from the hook portion until just before that the hook portion is hooked. Therefore, as to the fitting and mounting, the mount attachment can not be inclined and the fitting and mounting can be performed smoothly. Since the hook portion is relatively bent by the hooking introduction portion just before being hooked in the hook reception portion, an operator can feel following hooking on the hook reception portion. Therefor it is possible to certainly avoid a mounting defect of the mount attachment to the handler body.

In this case, it is preferable that the lever reception portion have a lever retention portion in which the handle lever is relatively inserted and mounted and the handle lever be inserted in the lever retention portion preceding to the hooking of the hook portion on the hook reception portion.

According to the structure, since the handle lever has been already inserted in the lever retention portion just before that the hook portion is hooked on the hook reception portion, spring force of the hook portion run on the hooking introduction portion is received by the lever retention portion. Therefore, it is possible to fit and mount the mount attachment in the lever reception portion (up to the hooking of the hook portion) smoothly.

Further, it is preferable that the lever reception portion have an attachment fitting portion on which the lever locking portion of the mount attachment is relatively fitted and mounted, and a base end surface of the mount attachment and a base end surface of the handler body be coplanar in a state that the lever locking portion is fitted in the lever reception portion and the hook portion is hooked in the lever reception portion. Still further, it is preferable that, with respect to a slider moving direction, a gap between the lever reception portion in the fitting state and the lever locking portion of the mount attachment in a vertical direction be small. This prevents the mount attachment from turning and can reduce backlash of the handler body.

According to the structure, since the mount attachment is hidden in the handler body mounted on the handle lever and can not be seen from an outside, a design of the handler body can not be degraded by the mount attachment.

Further, it is preferable that the lever locking portion have a pair of clamp spring portions that clamp to lock on the handle lever and a base portion on which the handle lever clamped by the pair of clamp spring portions is struck in a positioning state and from which the hook portion projects.

According to the structure, the handle lever is held at three points by the mount attachment fitted and mounted in the lever reception portion. In other words, the handle lever is held by the pair of clamp spring portions and the base portion of the lever locking portion. Therefore, the handler body can be mounted on the handle lever without backlash.

In this case, it is preferable that the pair of clamp spring portions and the base portion be disposed side by side in a direction orthogonal to a handling direction of the handle lever.

According to the structure, it is possible to dispose the handle lever and the mount attachment in the lever reception portion in a small space and the handler body can have any configuration (does not become large) even if the mount attachment is provided.

Further, it is preferable that the pressing member be mounted on the handler body from an opposite direction to a direction in which the mount attachment is fitted and mounted on the handler body and have a pressing boss formed with a cam inclined surface by which the hook portion is pressed in the hooking direction.

According to the structure, when the pressing member is mounted on the handler body, the cam inclined surface of the pressing boss automatically presses the hook portion in the hooking direction. Therefore, it is possible to easily set the handler body in the locked state. With a reverse procedure, the locked state of the handler body can be easily released.

While, it is preferable that the handler body have a slit groove portion that communicates with the lever reception portion and extends in a direction orthogonal to the handling direction, and the pressing member be formed in a plate-like shape and is detachably mounted in the slit groove portion.

According to the structure, it is possible to detachably mount the pressing member without worsening appearance configuration and strength of the handler body.

In this case, it is preferable that the pressing member be a position indicating member that indicates a handling position of the handler body.

According to the structure, the position indication member of the handler body and the pressing member can be structured by one member, which limits increase of the number of members. Further, in order to indicate the position of the handler body, the handler body does not need to be formed by a two-colored molding process and the handler body and the pressing member can have a simple configuration by molding. Therefore, production cost will be reduced as a whole. It is preferable that the handler body and the pressing member be colored with different colors to get enough contrast therebetween.

Further, it is preferable that an exposed surface of the pressing member mounted in the slit groove portion be formed approximately to be coplanar with an external surface of the handler body.

According to the structure, the pressing member does not project from the handler body seen from an outside, and design and operability of the handler body is not degraded.

Further, it is preferable that the slit groove portion extend to a base end of the handler body.

According to the structure, it is possible to easily detach the pressing member from the handler body by using the extended portion of the slit groove portion. In short, it is possible to detach the pressing member from the handler body without using a jig or the like and to release the locked state of the handler body on the handle lever.

It is preferable that the handler body have an engagement reception portion that engages with the mounted pressing member, and the pressing member have an engagement portion that engages with the engagement reception portion snappingly.

According to the structure, the mounted pressing member does not easily fall off from the handler body and a mounting defect of the pressing member on the handler body can be effectively prevented by the snap.

According to the invention, since the pressing member detachably mounted on the handler body presses the hook portion in the hooking direction with respect to the lever reception portion, the handler body is in the locked state with respect to the handle lever when the pressing member is mounted on the handler body, and the locked state is released when the pressing member is detached from the handler body. Therefore, it is possible to securely mount on the handle lever in the locked state and to detach easily as needed.

### BRIEF DESCRIPTION OF THE DRAWINGS

FIG. 1 is an exploded perspective view of a slide handler and a handle lever according to an embodiment.

FIG. 2 is a side elevational view of a state where a mount attachment is locked on the handle lever.

FIG. 3 is an explanatory view of a state just before mounting a handler body on the mount attachment and the handle lever.

FIG. 4A to 4C are explanatory views of a mount process where the handler body is mounted on the mount attachment and the handle lever, FIG. 4A illustrating at the beginning of the mount, FIG. 4B illustrating at the end of the mount and FIG. 4C illustrating at the completion of the mount.

FIGS. 5A and 5B are explanatory views of a mount process where a pressing member is mounted after the handler body is mounted on the mount attachment and the handle lever, FIG. 5A illustrating at the end of the mount and FIG. 5B illustrating at the completion of the mount.

### DESCRIPTION OF EXEMPLARY EMBODIMENTS

A slide handler according to one embodiment of the invention will be explained with reference to accompanying drawings. The slide handler is used for a handle tab, for example, of a fader of AV equipment and is detachably mounted on a handle lever of the fader for manipulating sound volume or sound quality.

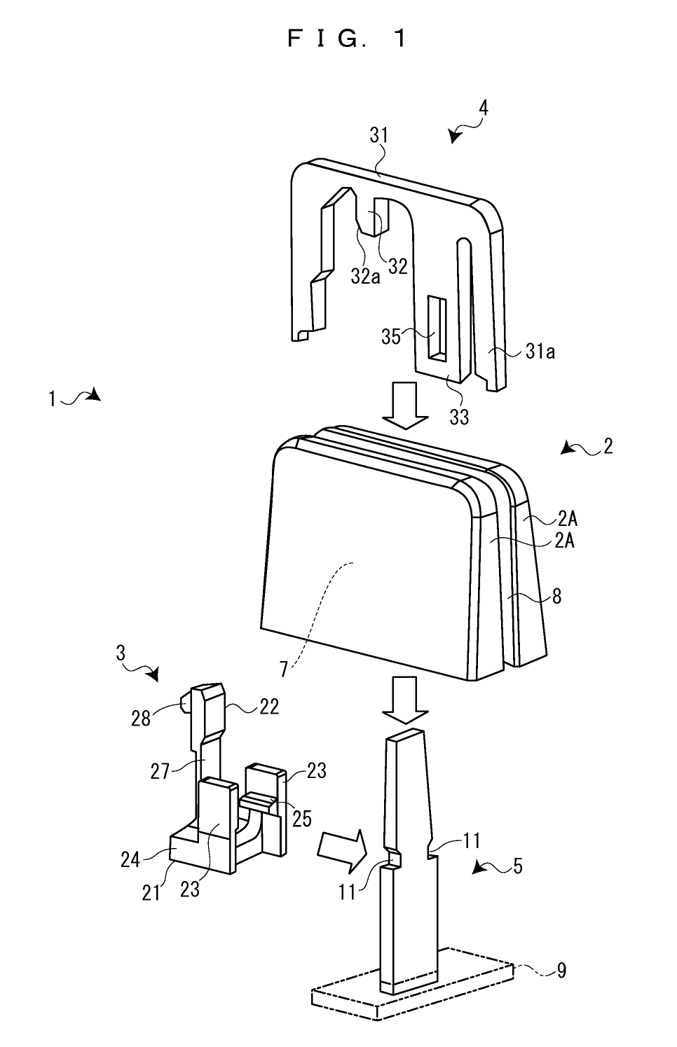

As illustrated in an exploded perspective view of FIG. 1, a slide handler 1 has a handler body 2 to be a tab portion, a mount attachment 3 accommodated with a top end side of a handle lever 5 inside the handler body 2 and a planar indication line member (pressing member) 4 constituting a position indication member for the handler body 2 which is mounted on the handler body 2 from an upper side. Inside the handler body 2, a lever reception portion 7 is formed in which the handle lever 5 and the mount attachment 4 are relatively mounted from a lower side, a slit groove portion 8 is formed in which the indication line member 4 is mounted from an upper side, and the lever reception portion 7 and the slit groove portion 8 communicate with each other. While, a base portion of the handle lever 5 is fixed to a slider 9 which slidingly contacts with a detection portion (operated portion) for position detection, and a position of the handle lever 5 can be detected by holding and slidingly operating the slide handler 1 mounted on the top end side of the handle lever 5.

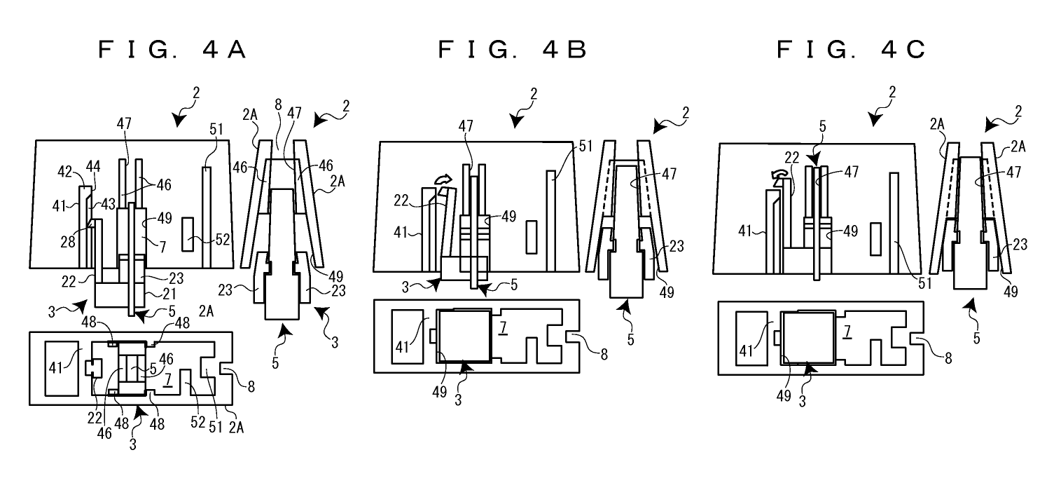

The handle lever 5 is made of an aluminum or a stainless steel plate which is processed by a press punching process, and a pair of hook grooves 11, 11 are formed at an intermediate position in an extending direction (vertical direction in FIG. 1). The pair of hook grooves 11, 11 are used for locking the above mentioned mount attachment 3 and a base portion side of each hook groove 11 is cut out orthogonally and a top end side thereof is cut out at a slant, thereby forming trapezoidal geometry as a whole. A top end side of the handle lever 5 with respect to the pair of hook grooves 11, 11 is formed in tapered trapezoidal geometry in some degree. The handler body 2 is mounted on the handle lever 5 from an upper side in a state that the mount attachment 3 is hooked in the pair of hook grooves 11, 11. In this state, an intermediate portion of the handle lever 5 including the pair of hook grooves 11, 11 is relatively engaged with the lever reception portion 7 of the handler body 2 via the mount attachment 3, and the top end side thereof is relatively and directly engaged with the lever reception portion 7 of the handler body 2 (see FIG. 4C). The handle lever 5 is attached on the slider 9 such that both sides of the handle lever 5 are in parallel in a sliding direction (operation direction) of the slider 9.

The mount attachment 3 is a plastic molding and is integrally formed by a lever locking portion 21 which is relatively fitted and mounted in the above mentioned lever reception portion 7 in a state that it is locked on the handle lever 3, and a hook portion 22 which is hooked in the lever reception portion 7 in a state that the fitting and mounting is completed. The lever locking portion 21 has a pair of clamp spring portions 23, 23 which lock to clamp on the handle lever 5, and a base portion 24 on which the handle lever 5 clamped by the pair of clamp spring portions 23, 23 is struck in a positioning state and from which the hook portion 22 projects. The pair of clamp spring portions 23, 23 are mounted with the handle lever 5 on an intermediate position of the handler body 2 in a width direction (horizontal direction), and the hook portion 22 and the base portion 24 are mounted at a position offset to either side from the intermediate position of the handler body 2 in the width direction (horizontal direction). After the mounting completes, a bottom surface (base end surface) of the base portion 24 and a bottom surface (base end surface) of the handler body 2 are coplanar.

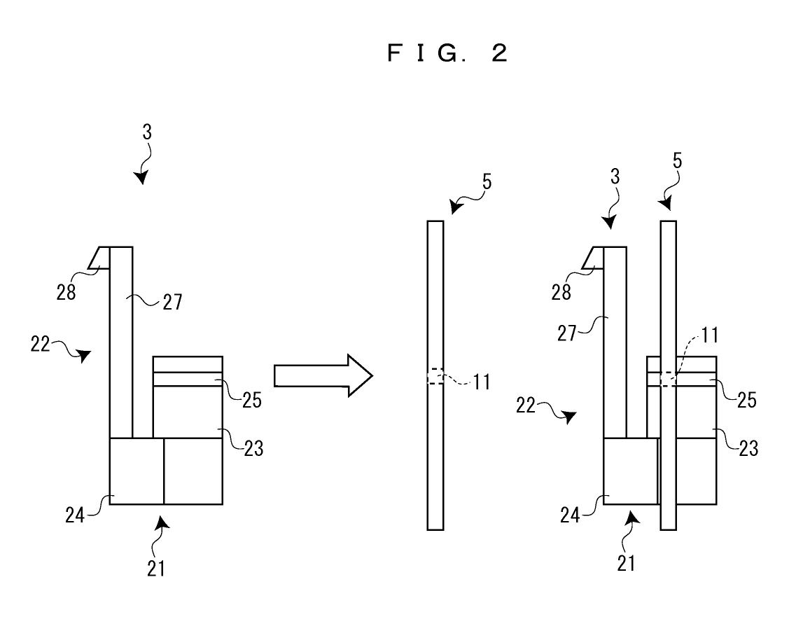

Upper half portions of the pair of clamp spring portions 23, 23 incline inwardly in accordance with a configuration of the lever reception portion 7 and allow the handle lever 5 to have strong clamp force after fitting and mounting in the lever reception portion 7 (see FIG. 4C). A hooking boss 25 which hooks in the hook groove 11 of the handle lever 5 is traversingly formed at the intermediate position in the vertical direction inside each clamp spring portion 23. The base portion 24 is formed in a square and the pair of spring portions 23, extend from an end side thereof. Either surface of the handle lever 5 clamped by the pair of clamp spring portions 23, 23 comes to contact with the end side therebetween. In other words, the locking (setting) of the mount attachment 3 to the handle lever 5 is completed by aligning each hooking boss 25 of the pair of clamp spring portions 23, 23 in the pair of hook groove 11, 11 of the handle lever 5, and sliding the mount attachment 3 to the handle lever 5 pushingly until the handle lever 5 abuts (the end side of) the base portion 24 (see FIG. 2).

The hook portion 22 is integrally formed by a plate spring portion 27 which is formed at a center portion of the base portion 24 in the vertical direction and a hook piece 28 which is provided at a top end portion of the plate spring portion 27. The plate spring portion 27 is formed in a thin plate shape and exerts relatively weak spring force in a bending direction. A lower surface of the hook piece 28 is orthogonal to the plate spring portion 27 and an upper surface thereof is inclined so as to form a triangle seen from a lateral side, and the hook piece 28 is hooked on a hook reception portion 42 described later of the lever reception portion 7 when the mount attachment 3 completes to fit and engage with the lever reception portion 7 (see FIGS. 4A-4C). Since the spring force of the hook portion 22 is weak, the hook portion 22 disengages with the hook reception portion 42 when the handler body 2 is pulled off strongly in a state that the indication line member 4 is detached (described later).

The indication line member 4 has functions by which the handler body 2 is kept in a locked state to the handle lever 5 by pressing the hook portion 22 in a locking direction against the lever reception portion (the hook reception portion 42 described later) 7, and by which an operation position of the handler body 2 is indicated when it is mounted on the intermediate position of the handler body 2 in the width direction (operation direction).

The indication line member 4 which constitutes a separate member from the handler body 2 is a plate-shaped plastic molding, and is integrally formed by an upside-down “U-shaped” member body 31 which constitutes a main body, a pressing boss 32 extending downwardly from an inside of the member body 31 and pressing the above mentioned hook portion 22, and an engagement portion 33 extending downwardly together with the pressing boss 32 from the inside of the member body 31.

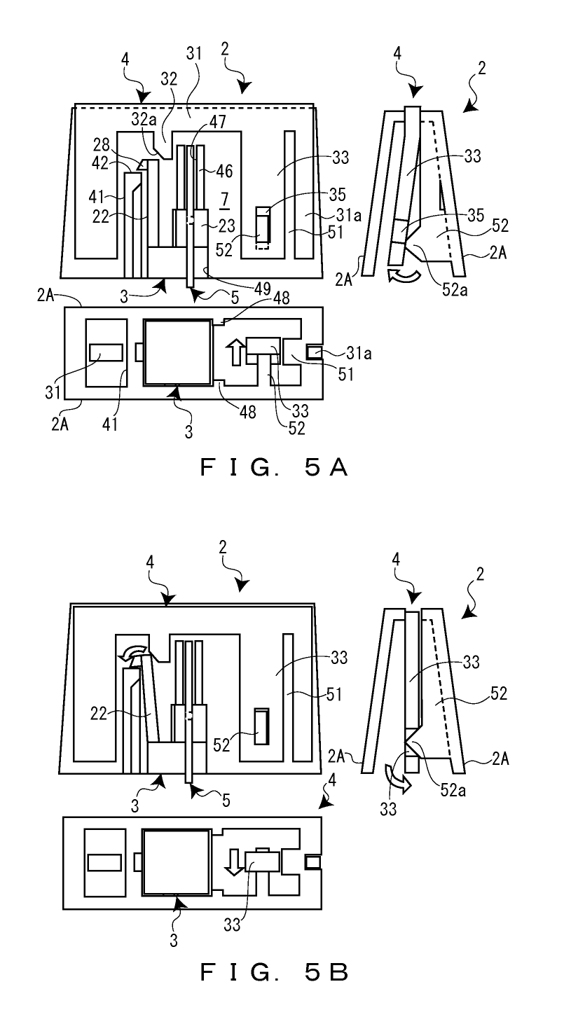

In a state that the indication line member 4 is mounted in the above mentioned slit groove portion 8, a peripheral surface of the member body 31 is exposed at the intermediate position of the handler body 2 in a thickness direction and the member body 31 indicates an operation position of the handler body 2. In short, when the indication line member 4 is mounted in the slit groove portion 8, the member body 31 is set to a position at which the peripheral surface thereof is coplanar with or slightly under the upper surface and both side surfaces of the handler body 2 (see FIGS. 5A and 5B). In a state that the member body 31 formed in a two pronged shape (“U”-shape) is mounted on the handler body 2, both bottom ends thereof reach at a lower end position of the handler body 2 and the indication line member 4 can be easily detached from the handler body 2 by pushing the member body 31 upwardly from the lower end of the slit groove portion 8. The indication line member 4 is colored so as to have enough contrast with respect to the handler body 2. For example, in a case that the handler body 2 is colored with black, the indication line member may be colored with white, or both are respectively colored with complementary colors.

The pressing boss 32 projects in a shape of square from the member body and a side which is engaged with the hook member 22 forms a cam inclined plane 32a. When the indication line member 4 is mounted in the slit groove portion 8, the cam inclined plane 32a of the pressing boss 32 presses the hook piece 28 of the hook portion 22 which is hooked in the lever reception portion (hook reception portion 42) 7 from a rear side (see FIG. 5B). In short, the pressing boss 32 presses the hook portion 22 in a hooking direction. This makes the hook piece 28 of the hook portion 22 immovable to be sandwiched between the lever reception portion 7 and the pressing boss 32. Consequently, the handler body 2 is in a retained state on the handle lever 5 via the mount attachment 3.

The engagement portion 33 projects lengthwise in a shape of rectangle from the member body 31 and a rectangular engagement aperture 35 is formed in a lower half portion thereof. In a state that the indication line member 4 is mounted in the slit groove portion 8, the engagement portion 33 exerts spring force in an orthogonal direction to an in-plane direction and engages in a boss-shaped engagement reception portion 52 described later snappingly. In other words, when the indication line member 4 is gradually mounted in the slit groove portion 8, a top end of the engagement portion 33 runs on the engagement reception portion 52 and the engagement reception portion 52 fits in the engagement aperture 35 snappingly, thereby the indication line member 4 is mounted in the handler body 2 completely (see FIGS. 5A and 5B). As described above, when the indication line member 4 is pushed up, the engagement aperture 35 comes off from the engagement reception portion 52 and the indication line member 4 can be easily detached from the handler body 2.

As illustrated in FIGS. 1 to 5B, the handler body 2 is a plastic molding and an appearance thereof is in a shape of wide trapezoid seen from a front face in the operation direction and in a shape of narrow trapezoid seen from a side face. As described above, the lever reception portion 7 in which the handle lever 5 and the mount attachment 3 are relatively and detachably mounted from a lower side is formed inside the handler body 2, and the slit groove portion 8 in which the indication line member 4 is detachably mounted from an upper side is formed. The lever reception portion 7 and the slit groove portion 8 communicate with each other (see FIGS. 5A and 5B).

In other words, the handler body 2 has a structure in which a pair of body element members 2A, 2A facing in the operation direction where the indication line member 4 is provided therebetween are connected by the portion on which the above described hook portion 22 is hooked, the portion in which the handle lever 5 is inserted, and a portion which guides to mount the indication line member 4. In short, the lever reception portion 7 and the slit groove portion 8 are formed in a space (space opening downwardly) between the pair of body element members 2A, 2A except the above described connection portions. Each connection portion does not come up with undercut in molding and has a shape which can be molded only with top and bottom molds.

The portion on which the hook portion 22 is hooked is formed by a partition portion 41 which extends upwardly from the lower ends of the pair of body element members 2A, 2A and the hook reception portion 42 where the hook piece 28 of the hook portion 22 is hooked on is formed on an upper end of the partition portion 41. At a side facing to the hook portion 22 of the partition portion 41, a guide groove 43 which guides the hook portion 22 in a free state to relatively hook on the hook reception portion 42 and a hooking introduction portion 44 which bends the hook portion 22 in the free state just before hooking are formed (see FIG. 4A). In other words, the guide groove 43 extends linearly from a lower end of the partition portion 41 to a position approximate to the hook reception portion 42 with respect to the hook reception portion 42 as a top portion of the partition portion 41, and the hooking introduction portion 44 is formed as a portion where the guide groove 43 is not formed between an upper end of the guide groove 43 and the hook reception portion 42.

A transit portion from the upper end of the guide groove 43 to the hooking introduction portion 44 is an inclined surface for bending the hook portion 22 in the free state. The hook piece 28 in the free state of the hook portion 22 relatively inserted into the lever reception portion 7 is guided by the guide groove 43. After the hook piece 28 runs on the hooking introduction portion 44, the hook portion 22 bends backwards, and finally the hook piece 28 moves from the upper end of the hooking introduction portion 44 to the hook reception portion 42, leading to hook the hook portion 22 on the hook reception portion (partition portion 41) 42 (see FIGS. 4A to 4C).

The portion into which the handle lever 5 is inserted is formed by a pair of facing plate portions 46, disposed between upper portions of the pair of body element members 2A, 2A (see FIG. 4A). A space between the pair of facing plate portions 46, 46 coincides with thickness of the handle lever 5 and a space between the pair of body element members 2A, 2A of this portion corresponds to width of the top end side of the trapezoidal handle lever 5. In other words, inner portions of the facing plate portions 46, 46 form lever retention portions 47 which are formed in a complementary shape with the top end side of the handle lever 5. Thus, when the handle lever 5 is relatively inserted into the lever reception portion 7, the handle lever 5 is held without backlash by the lever retention portions 47 which are the inside portions of the pair of facing plate portions 46, 46 at completion of the insertion.

A position of the top end of the handle lever 5 relatively inserted between lever retention portions 47 is set such that the hook portion 22 of the mount attachment 3 runs on the hooking introduction portion 44 at a position just before the completion of the insertion, and the top end portion of the handle lever 5 begins to insert (is inserted precedingly) between the lever retention portions 47 before the hook portion 22 in the free state reaches to the hooking introduction portion 44 (see FIG. 4B). Thus, the mount attachment 3 is fitted and mounted into the lever reception portion 7 smoothly.

The pair of clamp spring portions 23, 23 of the mount attachment 3 locked on the handle lever 5 are positioned in right and left directions by two positioning bosses at a left side and two positioning bosses at a right side, that is, four positioning bosses in total each of which projects from the pair of body element members 2A, 2A at a lower side of the pair of facing plate portions 46, 46 (see FIG. 4A). In short, a portion surrounded by the four positioning bosses 48 forms an attachment fitting portion 49. The mount attachment 3 locked on the handle lever 5 is relatively fitted and mounted in the attachment fitting portion 49 and is held immovably.

The upper half portions of the pair of clamp spring portions 23, 23 which are fitted and mounted and the pair of body element members 2A, 2A are formed in a complementary shape (comparatively tight fitting), and the pair of clamp spring portions 23, 23 clamp the handle lever 5 strongly in a state that the mount attachment 3 is mounted completely in the attachment fitting portion (lever reception portion 7) 49 (see FIG. 4C). In other words, the handler body 2 is mounted on the handle lever fixedly by the lever retention portion 47 and the pair of clamp spring portions 23, 23 described above. The lower surface of the mount attachment 3 (lower surface of the base portion 24) fitted and mounted in the attachment fitting portion 49 and the lower surface of the handler body 2 (lower surfaces of the pair of body element members) are coplanar, and the mount attachment 3 is substantially masked inside the handler body 2.

The portion which guides to mount the indication line member 4 is a portion corresponding to a spaced portion between one leg portion 31a of the member body 31 and the engagement portion 33 of the indication line member 4 and is formed by a connection portion 51 provided between the pair of body element member 2A, 2A (see FIGS. 5A and 5B). When the indication line member 4 is mounted, the connection portion 51 guides the one leg portion 31a of the member body 31 at an outer side thereof and guides the engagement portion 33 at an inner side thereof.

Further, at an inner side of one of the body element members 2A, 2A, the engagement reception portion 52 which is engaged with the engagement portion 33 of the indication member 4 snappingly is formed adjacent to the connection portion 51. The engagement reception portion 52 is a planar projection piece which projects inside the body element member 2A and a projection piece 52a of which upper and lower portions are inclined to form a trapezoidal shape is formed on the top end portion thereof (see FIGS. 5A to 5C). When the top end of the engagement portion 33 runs on the projection piece 52a and the engagement portion 33 fits in the engagement aperture 35, the indication line member 4 is mounted on the handler body 2. With a reverse procedure, the indication line member 4 is detached from the handler body 2.

Referring to FIGS. 2 to 5B, an assembly procedure of the handle lever 5 to the slide handler 1 will be explained. As illustrated in FIG. 2, first of all, the mount attachment 3 is attached to the handle lever 5 from a side (a direction orthogonal to the operation direction). More specifically, the hooking bosses 25 of the pair of clamp spring portions 23, 23 are aligned to the pair of hook grooves 11, 11 of the handle lever 5, and then, the mount attachment 3 is pushed until the handle lever 5 abuts the base portion 22 to lock on (set) the handle lever 5. At this moment, the mount attachment 3 is attached to the handle lever 5 in an positioning state by clamping force of the pair of clamp spring portions 23, 23 (temporary fixed state).

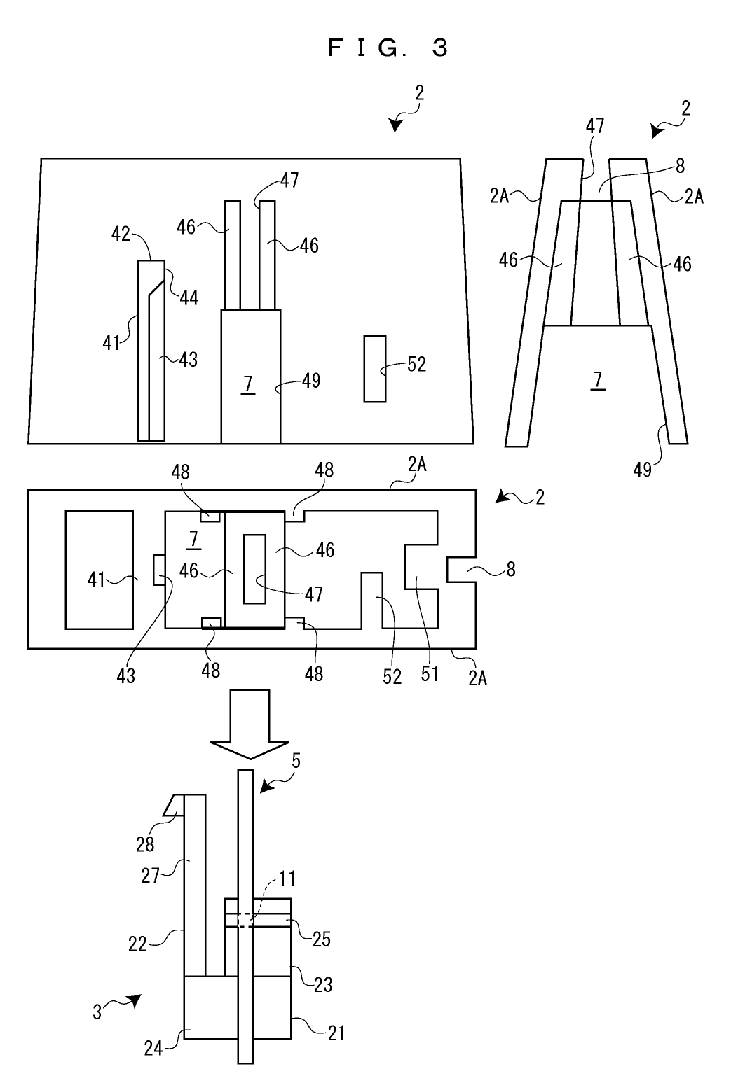

Then, as illustrated in FIG. 3, the lever reception portion 7 of the handler body 2 is positioned to the mount attachment 3 and the top end portion of the handle lever 5 which projects from the mount attachment 3. From this state, the handler body 2 is fitted on the handle lever 5 and the mount attachment 3 (see FIG. 4A). At this time, the handle lever 5 is guided by the lever retention portions 47, the hook portion 22 is guided by the guide groove 43, and further the lever locking portion 21 is guided by the attachment fitting portion 49 so that the handle lever 5 is inserted in the lever reception portion 7 of the handler body 2. Then, the hook portion 22 gets over the hooking introduction portion 44 to hook on the hook reception portion 42 (see FIGS. 4B and 4C). At the same time, the top end portion of the handle lever 5 reaches at penetralia of the lever retention portions 47 and the lever locking portion 21 also reaches at penetralia of the attachment fitting portion 49. Thus, relative fitting and mounting of the handler body 2 on the handle lever 5 and the mount attachment 3 is completed.

Then, the indication line member 4 is mounted in the handler body 2 mounted on the handle lever 5 from an upper side. First of all, the indication line member 4 is positioned to an outer shape of the handler body 2 and is inserted therein. As the insertion progresses, the pressing boss 32 of the indication line member 4 gets into touch with the hook portion 22 and begins to press the hook portion 22, and the engagement portion 33 runs on the engagement reception portion 52 (see FIG. 5A). At this moment, an operator feels a load on one's finger which pushes down the indication line member 4. The load is abruptly reduced when the engagement portion 33 snappingly engages with the engagement reception portion 52, and simultaneously the pressing boss 32 clamps the hook portion 22 with the hook reception portion 42. This completes attachment of the indication line member 4 and the handler body 2 is immovably mounted on the handle lever 5 in the retained state (see FIG. 5B).

While, in a case that the handler body 2 breaks or gets dirty, or the slider needs maintenance or replacement, the handler body 2 is detached by a reverse procedure described above. Specifically, the operator inserts a nail under a lower end of the slit groove portion 8 and pushes out the indication line member 4. This allows the engagement portion 33 to come off from the engagement reception portion 52. Then, the user olds and pulls out the upper end portion of the indication line member 4 which is out of the handler body 2. Finally, the operator pulls out the handler body 2 strongly to disengage the hook portion 22 with the hook reception portion 42.

As stated above, according to the embodiment, since the handler body 2 is mounted on the handle lever 5 attached with the mount attachment 3 having the hook portion 22 and the indication line member 4 is mounted on the handler body 2 to press the hook portion 22 in the hooking direction, the handler body 2 can be mounted immovably and in the retained state on the handle lever 5. Further, the handler body 2 can be easily dismounted from the handle lever 5 by detaching the indication line member 4 from the handler body 2. Further, it can be easily manufactured at low cost by the indication line member 4 having two functions. Still further, the slide handler 1 can have general versatility.

The pressing member which presses the hook portion in the hooking direction is not necessarily the indication line member which indicates an operation position of the handler body, and is not limited thereto only if the pressing member is mounted on the handler body and presses the hook portion in the hooking direction. Further, the hook piece of the hook portion may be bent inwardly and may hook on the pair of facing plate portions above. Still further, a boss may be provided on the engagement portion, an aperture may be formed in the engagement reception portion and the boss may engage in the aperture snappingly.

### REFERENCE NUMERALS

1: slide handler 2: handler body 3: mount attachment 4: indication line member 5: handle lever 7: lever reception portion 8: slit groove portion 9: 23: clamp spring portion 24: base portion 32: pressing boss 32a: cam inclined plane 33: engagement portion 41: partition portion 42: hook reception portion 43: guide groove 44: hooking introduction portion 47: lever retention portion 49: attachment fitting portion 52: engagement reception portion

What is claimed is:

1. A slide handler mounted on a top end portion of a handle lever of which a base end side is attached to a slider of an operated portion comprising:
a handler body that has a lever reception portion in which the handle lever is received;
a mount attachment that has a lever locking portion relatively fitted and mounted in the lever reception portion in a state that the lever locking portion is locked on the handle lever and that has a hook portion hooked in the lever reception portion in a state that the fitting and mounting is completed; and
a pressing member that is detachably mounted on the handler body and presses the hook portion in the lever reception portion in a hooking direction.

2. The slide handler according to claim 1, wherein the hook portion exerts spring force in a bending direction including the hooking direction, and the lever reception portion has a hook reception portion on which the hook portion is hooked, a guide groove that guides relative hooking action of the hook portion in a free state on the hook reception portion, and a hooking introduction portion that is provided between the hook reception portion and the guide groove and bends the hook portion just before hooking from the free state.

3. The slide handler according to claim 2, wherein the lever reception portion has a lever retention portion in which the handle lever is relatively inserted and mounted, and the handle lever is inserted in the lever retention portion preceding to the hooking of the hook portion on the hook reception portion.

4. A slide handler according to claim 1, wherein the lever reception portion has an attachment fitting portion on which the lever locking portion of the mount attachment is relatively fitted and mounted, and a base end surface of the mount attachment and a base end surface of the handler body are coplanar in a state that the lever locking portion is fitted in the lever reception portion and the hook portion is hooked in the lever reception portion.

5. The slide handler according to claim 1, wherein the lever locking portion has a pair of clamp spring portions that clamp to lock on the handle lever and a base portion on which the handle lever clamped by the pair of clamp spring portions is struck in a positioning state and from which the hook portion projects.

6. A slide handler according to claim 5, wherein the pair of clamp spring portions and the base portion are disposed side by side in a direction orthogonal to a handling direction of the handle lever.

7. The slide handler according 1, wherein the pressing member is mounted on the handler body from an opposite direction to a direction in which the mount attachment is fitted and mounted on the handler body and has a pressing boss formed with a cam inclined surface by which the hook portion is pressed in the hooking direction.

8. The slide handler according to claim 1, wherein the handler body has a slit groove portion that communicates with the lever reception portion and extends in a direction orthogonal to the handling direction, and the pressing member is formed in a plate-like shape and is detachably mounted in the slit groove portion.

9. The slide handler according to claim 8, wherein the pressing member is a position indicating member that indicates a handling position of the handler body.

10. The slide handler according to claim 8, wherein an exposed surface of the pressing member mounted in the slit groove portion is formed approximately to be coplanar with an external surface of the handler body.

11. The slide handler according to claim 8, wherein the slit groove portion extends to a base end of the handler body.

12. The slide handler according to claim 1, wherein the handler body has an engagement reception portion that engages with the mounted pressing member, and the pressing member has an engagement portion that engages with the engagement reception portion snappingly.
